(19) United States
(12) Patent Application Publication
(10) Pub. No.: US 2004/0129712 A1
(43) Pub. Date: Jul. 8, 2004

(54) Customizable container identification system

(76) Inventor: Sharon Egan, Ketchum, ID (US)

Correspondence Address: PERKINS COIE LLP, PATENT-SEA, P.O. BOX 1247, SEATTLE, WA, 98111-1247, US

(21) Appl. No.: 10/462,306

(22) Filed: Jun. 13, 2003

Related U.S. Application Data
(60) Provisional application No. 60/439,060, filed on Jan. 8, 2003.

(51) Int. Cl. A47J 39/00; A47J 41/00

(52) U.S. Cl. 220/592.16

(57) ABSTRACT

Various aspects of the invention provide user-customizable labels on containers. In one particular example, a label is affixed to an exterior surface of a beverage container. The label comprises a base and a customizable field, with a removable opaque layer of material on the customizable field covering at least a portion of the underlying base. In another example, a user may uniquely identify a container by selectively removing portions of such a removable opaque layer to reveal an underlying second layer of material. The selectively removed portions can thus define a user-created indicium that uniquely identifies the container as the user's own.

### CROSS-REFERENCE TO RELATED APPLICATIONS

This non-provisional application claims priority to Provisional U.S. Patent Application No. 60/439,060 (attorney docket number 37408.8001 US), entitled CUSTOMIZABLE CONTAINERS AND METHOD FOR CUSTOMIZING CONTAINERS, filed Jan. 8, 2003, hereby incorporated in its entirety by reference thereto.

### TECHNICAL FIELD

The present invention generally relates to containers. More particularly, several aspects of the present invention are related to user-customizable labels on beverage containers.

### BACKGROUND

Containers sold to consumers, such as beverage containers, typically have a label applied to the external surface of the container by the manufacturer. Such labels are commonly formed of paper, plastic, laminated paper, or the like, and are preprinted with text and/or graphics selected by the manufacturer. The manufacturer applies the same labels to a large number of containers, and a number of identical or very similar containers may be packaged together for sale. However, if users open more than one of these identically- or similarly-labeled containers at one time, it can be difficult or impossible to distinguish the containers from one another.

By way of example, in larger gatherings of consumers, e.g., parties or sporting events, a number of people may have open beverage containers, each of which has an identical label. In such a context, it can be it difficult for one person increasingly concerned about communicable diseases that can be passed on by sharing the same drink. Therefore, uniquely identifying one's own beverage container can be advantageous. However, most containers do not provide any easy way for a consumer to add user-created indicia to identify his or her container. Instead, most consumers must use a separate writing implement, e.g., a pen or pencil, to write their names or other indicia on the container. Others have proposed a separate attachment, such as a tag or a sleeve, that is personalized to uniquely identify a container. This, however, requires consumers to carry their own individualized tags or sleeves with them, which is unlikely in most circumstances.

Some have also proposed incorporating game pieces on containers, e.g., beverage cups at fast food restaurant chains. Typically, such game pieces include printed text indicating the outcome of the game (e.g., identifying a prize) covered with a scratch-off coating. This may be a simple way to promote sales of a product, but it does not permit the consumer to uniquely identifying a container as his or her own.

### BRIEF DESCRIPTION OF THE DRAWINGS

FIG. 1 is an isometric view of a customizable container in accordance with one embodiment of the invention.

FIG. 2 is a broken-away cross-sectional view of a portion of the container of FIG. 1.

FIG. 3 is a broken-away cross-sectional view of a portion of a container in accordance with another embodiment of the invention.

FIG. 4 is a broken-away cross-sectional view of a portion of a container in accordance with still another embodiment of the invention.

FIG. 5 is a broken-away cross-sectional view of a portion of a container in accordance with a further embodiment of the invention.

FIG. 6 is an isolation isometric view of the container of FIGS. 1 and 2 bearing a user-created indicium in accordance with one embodiment of the invention.

FIG. 7 is an isolation isometric view of the container of FIGS. 1 and 2 bearing a user-created indicium in accordance with one embodiment of the invention.

### DETAILED DESCRIPTION

In the following description, numerous specific details are provided, such as the identification of various system components, to provide a thorough understanding of embodiments of the invention. One skilled in the art will recognize, however, that the invention can be practiced without one or more of the specific details, or with other methods, components, materials, etc. In still other instances, well-known structures, materials, or operations are not shown or described in detail to avoid obscuring aspects of various embodiments of the invention.

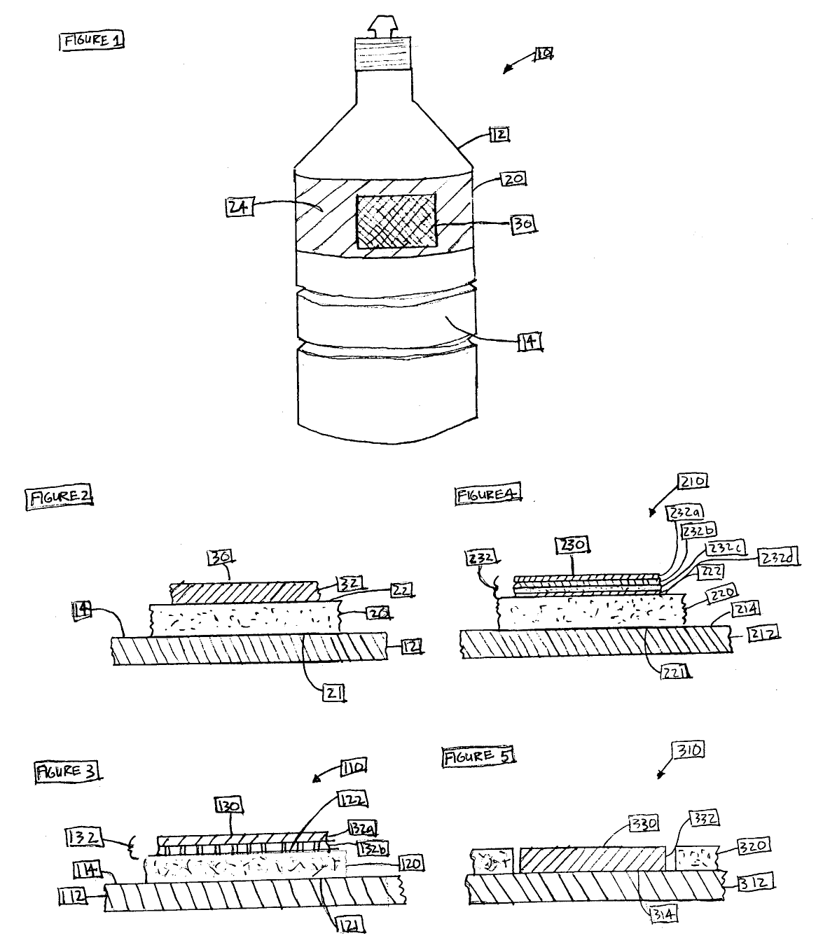

FIG. 1 is an isometric view of a customizable container 10. The customizable container 10 can include a container 12 and a label 20. The container 12 carries the label 20 on an exterior surface 14 of the container 12. In the illustrated embodiment, the container 12 is typified as a disposable plastic water bottle, but this is primarily for purposes of illustration. In other embodiments, any of a variety of containers may be used, e.g., glass bottles or metal cans.

The label 20 includes a base portion 24 and a customizable field 30 for receiving a user-created indicium. The base portion 24 of the label 20 may comprise a paper, plastic, or laminated material bearing preprinted product and/or manufacturer identifying information. In one embodiment, the label 20 and the container 12 are manufactured separately. The label 20 can be pre-printed on a sheet containing a plurality of identical labels. The labels on the sheet are then individually cut out and each affixed to a container. In the illustrated embodiment, the label 20 is applied to the exterior surface 14 of the container 12, e.g., using an adhesive.

FIG. 2 is a cross-sectional view of the customizable field 30 portion of the label 20 of FIG. 1. The label 20 includes a first side 21 and a second side 22 opposite the first side 21. The first side 21 of the label 20 is affixed to the exterior surface 14 of the container 12. In one embodiment, the customizable field 30 can include a removable opaque layer 32 that covers at least a portion of the label 20. A user-created indicium can be formed by a user selectively removing portions of the removable opaque layer 32 to reveal the underlying second side 22 of the label 20.

The removable opaque layer 32 may be similar to the scratch-off layer employed on lottery tickets or the like and is configured to be removable with a fingernail. Scratch-off layers typically include a removable opaque layer with an underlying layer of contrasting color that is more resistant to scratching than the opaque layer. For example, in one embodiment a black opaque layer 32 may be employed with an underlying white label 20. Optionally, in another embodiment a separate block of color may be printed on a label generally coextensive with a removable opaque layer. A further embodiment may include a removable opaque layer printed over a block of patterned color and/or shapes that form no discernable text. For example, the pattern may include a series of multi-colored (e.g., black and white) swirls, stripes, or any other variety of shapes or lines that form a pattern. Thus, scratching off the opaque layer 32 to create the user-created indicium will expose portions of the underlying pattern on the customizable field. The image, therefore, would be variegated in a relatively random fashion.

The removable opaque layer 32 of the customizable field 30 may be applied to the label 20 in any suitable fashion. For example, the removable opaque layer 32 may be printed using a standard spot- or four-color process using conventional silk-screening or UV flexographic printing. Printing services are commercially available from a variety of vendors, including silk-screen printing from Edwards Label of 227 West Knoll Drive, Ventura, Calif., and UV flexographic printing from Epsen-Hillmer Graphics of 2000 California Street, Omaha, Nebr.

FIG. 3 is a broken-away cross-sectional view of a portion of a customizable container 110 in accordance with a further embodiment of the invention. A label 120 includes a first side 121 and a second side 122 opposite the first side 121. The first side 121 of the label 120 is affixed to an exterior surface 114 of a container 112. The container 112 and label 120 can be generally similar to the container 12 and label 20 respectively, described above with reference to FIGS. 1 and 2. In the embodiment illustrated in FIG. 3, however, the customizable field 130 includes a multi-layer film stack 132 covering a portion of the label 120. The film stack 132 may be applied to the label 120 either before or after the first side 121 of the label 120 is affixed to the exterior surface 114 of the container 112.

The film stack 132 comprises an outer layer 132a and an inner layer 132b. The outer layer 132a is a removable opaque layer similar to the removable opaque layer 32 described above with reference to FIGS. 1 and 2. The underlying inner layer 132b is a material more resistant to scratching than the outer layer 132a. In this embodiment, a user selectively removes portions of the outer layer 132a to reveal the underlying inner layer 132b. The label 120, however, is not revealed beneath the customizable field 130. Rather, only portions of the inner layer 132b are revealed when a user selectively removes portions of the outer layer 132a to form a user-created indicium. This may allow manufacturers more freedom in selecting the colors printed on the label 120 while ensuring adequate contrast between the outer layer 132a and the indicium to make the indicium readily visible.

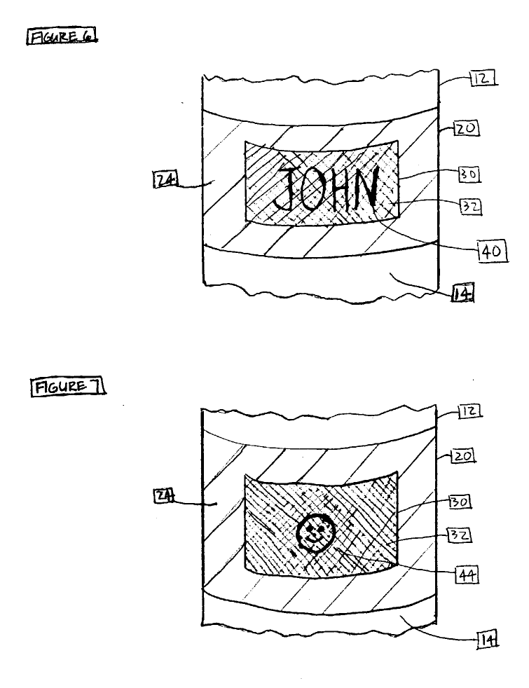

FIG. 4 illustrates another customizable container 210 employing a multi-layered customizable field. In this embodiment, a label 220 includes a first side 221 and a second side 222 opposite the first side 221. The first side 221 of the label 220 is affixed to an exterior surface 214 of a container 212. The container 212 and label 220 can be generally similar to the container 12 and label 20 described above with reference to FIGS. 1 and 2. A film stack 232 comprises a plurality of removable opaque layers 232a-232d that are each visually distinguishable, e.g., a different color, from the adjacent layers. By varying the force with which the user scratches the customizable field 230, the color exposed by that scratching can be varied. This will enable users to personalize the container 212 using multi-colored alphanumeric indicia or symbols. The film stack 232 illustrated in FIG. 4 has four layers, but any number of visually distinguishable layers may be used.

Another embodiment of a customizable container 310 with a customizable field is shown in FIG. 5. In this embodiment, a customizable field 330 can be applied directly to an exterior surface 314 of a container 312 without first being applied to an intermediary layer, such as label 320. When a user selectively removes portions of a removable opaque layer 332, the exterior surface 314 of the container 312 will be partially exposed. The exterior surface 314 of the container 312 in this embodiment may have a contrasting color to the removable opaque layer 332.

As illustrated in FIGS. 6 and 7, a user can customize the container 12 by writing or drawing an indicium of their own choosing on the customizable field 30. Although FIGS. 6 and 7 depict the container 12 of FIGS. 1 and 2 with a user-created indicium, any other suitable container design, e.g., one of containers 112, 212, and 312, could be used instead.

Referring to FIG. 6, the customizable field 30 covers at least a portion of the base portion 24 of label 20, which is affixed to the exterior surface 14 of the container 12. A user has selectively removed portions of the removable opaque layer 32 on the customizable field 30 to form a user-created indicium 40. The removable opaque layer 32 can be removed by the user with a fingernail, a coin, an eraser, or the like. The ability to selectively remove portions of the removable opaque layer 32 with a fingernail avoids the necessity of requiring a user to use a separate writing instrument or tool, which may be inconvenient and impractical at most social gatherings.

Any suitable user-created indicia may be written or drawn on the customizable field 30, including alphanumeric indicia or symbols. In FIG. 6, for example, a user chose to customize the container 12 by scratching his name, “John,” on the removable opaque layer 32 of the customizable field 30. Alternatively, the user of the container 12 in FIG. 7 chose to mark the removable opaque layer 32 of the customizable field 30 with a symbol 44 to uniquely identify the container 12 as his or her own.

As noted above, other embodiments of the invention provide methods of uniquely identifying a container. In the following discussion, reference is made to the particular customizable container 10 shown in FIGS. 1-2. It should be understood, though, that reference to this particular customizable container 10 is solely for purposes of illustration and that the method outlined below is not limited to any particular customizable container shown in the drawings or discussed in detail above.

In one embodiment, a method of the invention may include affixing a label 20 with a customizable field 30 to a container 12. Next, a number of identical containers, each including a customizable field on its label, are packaged and shipped together. After shipping, each identically-packaged container 12 can be uniquely identified by a user selectively removing portions of a removable opaque layer 32 on the customizable field 30 of the label 20, thus defining a user-created indicium. By way of example, a bottler may sell water in cases of identical water bottles. One of these cases may be purchased for a group of people at a social gathering, e.g., a team of players at a soccer game. Each member of the soccer team may select a bottle of water and customize it with a personally-selected indicium, thus uniquely identifying the bottle as his or her own.

A customizable field with a removable opaque layer, described above with respect to various embodiments, is advantageous for several reasons. For example, uniquely identifying one's container can reduce the spread of germs caused by people inadvertently drinking out of the wrong beverage container. Additionally, uniquely identifying each container can reduce confusion at large gatherings or events (e.g., the previously-mentioned soccer game) where there are a large number of open containers of the same product.

Methods to uniquely identify a container in accordance with select embodiments of the invention can provide a material advantage for products marketed to children because the children will easily be able to mark the container and enjoy creating unique marks identifying their individual containers. The embodiments mentioned above with multi-colored removable opaque layers and multi-colored patterns are expected to particularly appeal to children.

Unless the context clearly requires otherwise, throughout the description and the claims, the words “comprise,” “comprising,” and the like are to be construed in an inclusive sense as opposed to an exclusive or exhaustive sense, that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list.

The above-detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, whereas steps are presented in a given order, alternative embodiments may perform steps in a different order. The various embodiments described herein can be combined to provide further embodiments.

In general, the terms used in the following claims should not be construed to limit the invention to the specific embodiments disclosed in the specification, unless the above-detailed description explicitly defines such terms. While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

I/We claim:

1. A customizable container, comprising:
a container having an exterior surface and an interior surface, wherein the interior surface defines an interior volume; and
a label carried by the container, the label comprising a customizable field having a first layer covering at least a portion of a second layer that is positioned closer to the container than the first layer, the first layer having portions selectively removed to expose the underlying second layer, the selectively removed portions defining a user-created indicium.

2. The customizable container of claim 1 wherein the container is a disposable beverage container.

3. The customizable container of claim 1 wherein the first layer is a removable opaque material and the second layer is a material more resistant to scratching than the first layer.

4. The customizable container of claim 1 wherein the first layer is a first color and the second layer is a second color, and the first color contrasts with the second color.

5. The customizable container of claim 1 wherein the second layer has a pattern that forms no discernable text.

6. The customizable container of claim 1 wherein the first layer comprises a film stack including a plurality of removable opaque layers with each layer being visually distinguishable from each adjacent layer, and the selectively removed portions of the first layer have varying depths, thereby defining a visibly varied user-created indicium.

7. The customizable container of claim 1 wherein the first layer is adapted for selective removal using a fingernail.

8. The customizable container of claim 1 wherein the label further comprises a flexible sheet attached to the external surface of the container.

9. The customizable container of claim 1 wherein the first layer comprises a polymer printed on the second layer by silk-screening or UV flexographic printing.

10. A customizable container, comprising:
a container; and
a customizable label carried by the container, wherein a portion of the label is selectively reconfigurable by a user to uniquely identify the container.

11. The customizable container of claim 10 wherein the container is a disposable beverage container.

12. The customizable container of claim 10 wherein the selectively reconfigurable portion of the label has a first layer overlying a second layer, the first layer being a removable opaque material and the second layer being more resistant to scratching than the first layer.

13. The customizable container of claim 10 wherein the selectively reconfigurable portion of the label has a first layer that is a first color overlying a second layer that is a second color, and the first color contrasts with the second color.

14. The customizable container of claim 10 wherein the second layer has a pattern that forms no discernable text.

15. The customizable container of claim 10 wherein the selectively reconfigurable portion of the label is adapted for removal using a fingernail.

16. A beverage container with indicia for customization, comprising:
a container having an exterior surface and an interior surface, wherein the interior surface defines an interior volume; and
a label affixed to the exterior surface of the container, the label comprising a base and a customizable field with a removable opaque material covering at least an underlying portion of the base.

17. The beverage container of claim 16 wherein the removable opaque material is a first color and the base is a second color, and the first color contrasts with the second color.

18. The beverage container of claim 16 wherein the removable opaque material is adapted for selective removal using a fingernail.

19. The beverage container of claim 16 wherein the customizable field comprises a polymer printed on the label by silk-screening or UV flexographic printing.

20. A method for uniquely identifying a container, comprising selectively removing portions of a removable opaque layer of material on a customizable label to reveal an underlying second layer of material, the removed portions defining a user-created indicium.

21. The method of claim 20 wherein selectively removing portions of a removable opaque layer comprises scratching the removable opaque material with a user's fingernail.

22. The method of claim 20 wherein the underlying second layer of material is more scratch-resistant than the removable opaque layer of material.

23. A method for uniquely identifying a container, comprising:
affixing a customizable label to a container;
shipping the container with the customizable label; and
after shipping the container, selectively removing portions of a removable opaque layer of material on the customizable label, defining a user-created indicium.

24. The method of claim 23 wherein selectively removing portions of a removable opaque layer comprises scratching the removable opaque material with a user's fingernail.

25. The method of claim 23 wherein the label is a first label and the container is a first container, further comprising:
affixing a second label to a second container;
shipping the first and second containers together; and
after shipping the first and second containers, selectively removing portions of a removable opaque layer of material on the second label, defining a user-created indicium on the second label that is different than the indicium on the first label.
